(19) United States
(12) Patent Application Publication
(10) Pub. No.: US 2024/0262318 A1
(43) Pub. Date: Aug. 8, 2024

(54) VEHICLE SENSOR ASSEMBLY

(71) Applicant: Ford Global Technologies, LLC, Dearborn, MI (US)

(72) Inventors: David Michael Herman, West Bloomfield, MI (US); Venkatesh Krishnan, Canton, MI (US)

(73) Assignee: Ford Global Technologies, LLC, Dearborn, MI (US)

(21) Appl. No.: 18/166,044

(22) Filed: Feb. 8, 2023

(51) Int. Cl. B60S 1/56; B60R 1/22; B60S 1/48; B60S 1/54; B60W 30/09; G06V 10/82

(52) U.S. Cl. CPC B60S 1/56; B60R 1/22; B60S 1/481; B60S 1/54; B60W 30/09; G06V 10/82; B60W 2420/403

(57) ABSTRACT

A system includes a camera assembly designed to capture image data at a plurality of focal lengths and a computer in communication with the camera assembly. The computer has a processor and a memory storing instructions executable by the processor to receive first image data captured by the camera assembly at a first focal length and receive second image data captured by the camera assembly at a second focal length, the second focal length greater than the first focal length. The instructions include instructions to actuate a cleaning system based on the first image data captured at the first focal length and the second image data captured at the second focal length.

### BACKGROUND

Vehicles can include a variety of sensors. Some sensors detect internal states of the vehicle, for example, wheel speed, wheel orientation, and engine and transmission values. Some sensors detect the position or orientation of the vehicle, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. Some sensors detect the external world, for example, radar sensors, scanning laser range finders, light detection and ranging (LIDAR) devices, and image processing sensors such as cameras. A LIDAR device detects distances to objects by emitting laser pulses and measuring the time of flight for the pulse to travel to the object and back.

### BRIEF DESCRIPTION OF THE DRAWINGS

FIG. 1 is a perspective view a vehicle with a plurality of camera assemblies.

FIG. 2 is a diagram showing components of the camera assembly.

FIG. 3 is a diagram showing components of the camera assembly.

FIG. 4 is a block diagram of components of the vehicle including a computer in communication with the camera assemblies.

FIG. 5 is a diagram of a neural network of the computer.

FIG. 6 is a flow chart illustrating a process for controlling the vehicle.

### DETAILED DESCRIPTION

A system includes a camera assembly designed to capture image data at a plurality of focal lengths and a computer in communication with the camera assembly. The computer has a processor and a memory storing instructions executable by the processor to receive first image data captured by the camera assembly at a first focal length. The instructions include instructions to receive second image data captured by the camera assembly at a second focal length, the second focal length greater than the first focal length. The instructions include instructions to actuate a cleaning system based on the first image data captured at the first focal length and the second image data captured at the second focal length.

The instructions may include instructions to actuate at least one of a brake system, a steering system, or a propulsion system based on the first image data captured at the first focal length and the second image data captured at the second focal length.

The system may include a transparent shield with an outer surface. The instructions may include instructions to determine whether an object in a field of view of the camera assembly is either on the outer surface or spaced from the outer surface based on the first image data captured at the first focal length and the second image data captured at the second focal length, instructions to, in response to determining the object is on the outer surface, actuate the cleaning system, and instructions to, in response to determining the object is spaced from the outer surface, actuate at least one of the brake system, the steering system, or the propulsion system.

The instructions may include instructions to determine whether the object in the field of view of the camera assembly is either on the outer surface or spaced from the outer surface with a neural network trained to use the first image data captured at the first focal length and the second image data captured at the second focal length as input data.

The instructions may include instructions to actuate the cleaning system to provide either air or liquid based on the first image data captured at the first focal length and the second image data captured at the second focal length.

The instructions and include instructions to determine whether an object is either solid or liquid based on the first image data captured at the first focal length and the second image data captured at the second focal length, instructions to, in response to determining the object is liquid, actuate the cleaning system to provide air, and instructions to, in response to determining the object is solid, actuate the cleaning system to provide liquid.

The instructions may include instructions to select a subset of nozzles from among a plurality of nozzles of the cleaning system based on the first image data captured at the first focal length and the second image data captured at the second focal length, and instructions to actuate the cleaning system to provide fluid via the selected subset of nozzles.

The camera assembly may include a lens assembly and the instructions may include instructions to identify fog entrapped in the lens assembly based on the first image data captured at the first focal length and the second image data captured at the second focal length.

The camera assembly may include a plenoptic camera.

The camera assembly may include an image sensor, a first micro lens defining the first focal length and positioned to direct light at a first portion of the image sensor, and a second micro lens defining the second focal length and positioned to direct light at a second portion of the image sensor.

The first focal length may be within 40 to 160 millimeters of the camera assembly and the second focal length at least 10 meters from the camera assembly.

A vehicle includes a propulsion system, a brake system, and a steering system. The vehicle includes a camera assembly. The vehicle includes a computer in communication with the camera assembly. The computer has a processor and a memory storing instructions executable by the processor to receive first image data captured at a first focal length from the camera assembly. The instructions include instructions to receive second image data capture at a second focal length from the camera assembly, the second focal length greater than the first focal length. The instructions include instructions to actuate at least one of the propulsion system, the brake system, or the steering system based on the first image data captured at the first focal length and the second image data captured at the second focal length.

The vehicle may include a cleaning system. The instructions may include instructions to actuate the cleaning system based on the first image data captured at the first focal length and the second image data captured at the second focal length.

The instructions may include instructions to determine whether an object in a field of view of the camera assembly is either on the vehicle or spaced from the vehicle based on the first image data captured at the first focal length and the second image data captured at the second focal length, instructions to, in response to determining the object is on the vehicle, actuate cleaning system, and instructions to, in response to determining the object is spaced from the vehicle, actuate at least one of the brake system, the steering system, or the propulsion system.

The instructions may include instructions to determine whether the object in the field of view of the camera is either on the vehicle or spaced from the vehicle with a neural network trained to use the first image data at the first focal length and the second image data at the second focal length as input data.

The first focal length may be between the camera assembly and a front end of the vehicle, and the second focal length beyond the front end of the vehicle.

A method includes receiving first image data captured by a camera assembly at a first focal length. The method includes receiving second image data captured by the camera assembly at a second focal length, the second focal length greater than the first focal length. The method includes actuating a cleaning system based on the first image data captured at the first focal length and the second image data captured at the second focal length. The method includes actuating at least one of a brake system, a steering system, or a propulsion system based on the first image data captured at the first focal length and the second image data captured at the second focal length.

The method may include actuating the cleaning system to provide either air or liquid based on the first image data captured at the first focal length and the second image data captured at the second focal length.

The method may include identifying fog entrapped in a lens assembly of the camera assembly based on the first image data captured at the first focal length and the second image data captured at the second focal length.

With reference to the Figures, wherein like numerals indicate like parts throughout the several views, a vehicle 20 with a system 22 to operate components of the vehicle 20 is shown. The system 22 includes a camera assembly 24 designed to capture image data at a plurality of focal lengths. The system 22 includes a computer 26 in communication with the camera assembly 24. The computer 26 has a processor and a memory storing instructions executable by the processor to receive first image data captured by the camera assembly 24 at a first focal length FL1. The instructions include instructions to receive second image data captured by the camera assembly 24 at a second focal length FL2, the second focal length FL2 greater than the first focal length FL1. The instructions include instructions to actuate a cleaning system 28 based on the first image data captured at the first focal length FL1 and the second image data captured at the second focal length FL2. The instructions may include instructions to operate one or more vehicle systems or components, and/or may prompt a vehicle operator for input, based on the first image data captured at the first focal length FL1 and the second image data captured at the second focal length FL2.

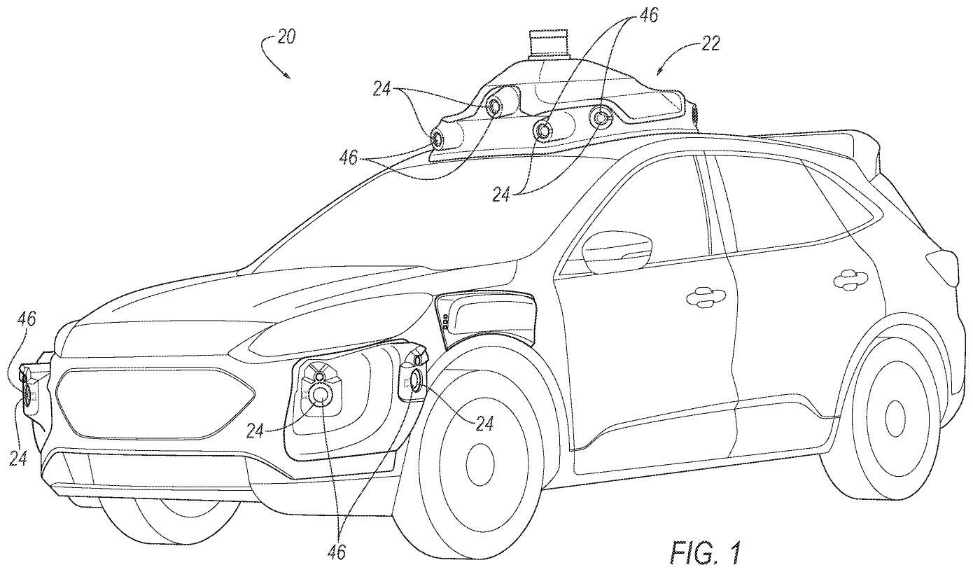

With reference to FIG. 1, the vehicle 20 may be any suitable type of ground vehicle, e.g., a passenger or commercial automobile such as a sedan, a coupe, a truck, a sport utility, a crossover, a van, a minivan, a taxi, a bus, etc.

The vehicle 20 includes a vehicle frame and the body 30. The vehicle 20 frame and the body 30 may be of a unibody construction in which the frame is unitary with the body 30, including frame rails, pillars, roof rails, etc. As another example, the frame and the body 30 may have a body-on-frame construction also referred to as a cab-on-frame construction in which the body 30 and the frame are separate components, i.e., are modular, and the body 30 is supported on and affixed to the frame. Alternatively, the frame and body 30 may have any suitable construction. The frame and the body 30 may be of any suitable material, for example, steel, aluminum, and/or fiber-reinforced plastic, etc. The body 30 may include a roof that extends along a top of the vehicle 20, e.g., over a passenger cabin of the vehicle 20. The body 30 may include a front fascia at a forward most end of the body 30.

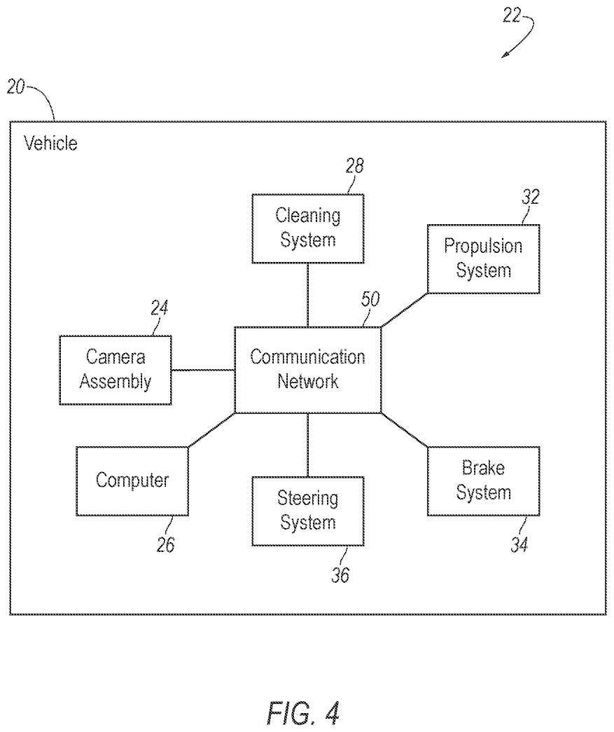

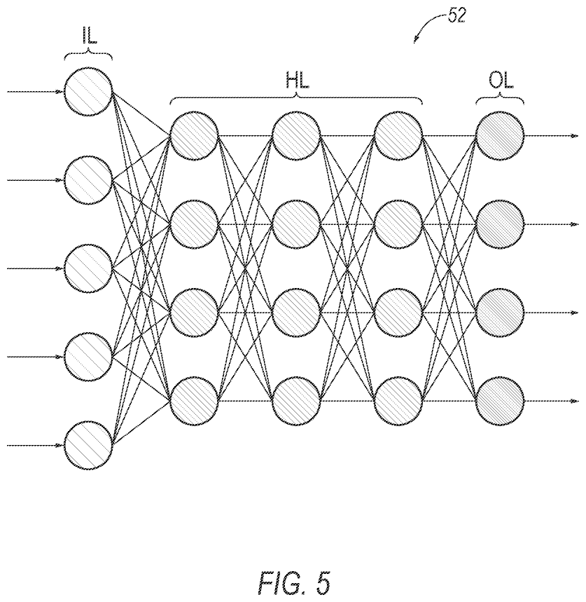

The vehicle 20 includes a propulsion system 32 (see FIG. 4) that generates force to move the vehicle 20, e.g., in a forward or reverse direction. The propulsion system 32 may include one or more of an internal combustion engine, electric motor, hybrid engine, etc. The propulsion system 32 is in communication with and receives input from the computer 26 and/or a human operator. The human operator may control the propulsion system 32 via, e.g., an accelerator pedal.

The vehicle 20 includes a brake system 34 (see FIG. 4) that resists motion of the vehicle 20 to thereby slow and/or stop the vehicle 20. The brake system 34 may include friction brakes such as disc brakes, drum brakes, band brakes, and so on; regenerative brakes; any other suitable type of brakes; or a combination. The brake system 34 is in communication with and receives input from the computer 26 and/or a human operator. The human operator may control the brake system 34 via, e.g., a brake pedal.

The vehicle 20 includes a steering system 36 (see FIG. 4) that controls turning of wheels of the vehicle 20, e.g., toward a right or left of the vehicle 20. The steering system 36 may include a rack-and-pinion system with electric power-assisted steering, a steer-by-wire system, e.g., such as are known, or any other suitable system that controls turning of wheels of the vehicle 20. The steering system 36 is in communication with and receives input from a steering wheel and/or the computer 26.

The vehicle 20 includes one or more camera assemblies 24 that may be supported by the frame and body 30 of the vehicle 20, e.g., on the roof, at the front facia, etc. The camera assembly 24 captures images that may be used by the computer 26 to autonomously or semi-autonomously operate the vehicle 20. In other words, image data collected by the camera is of sufficient quality and quantity, for example, to enable speed control, lane-keeping, etc., e.g., as part an advanced driver assist system (ADAS) that includes the computer 26. For example, the camera assembly 24 may collect data at a threshold resolution, a threshold refresh rate, etc.

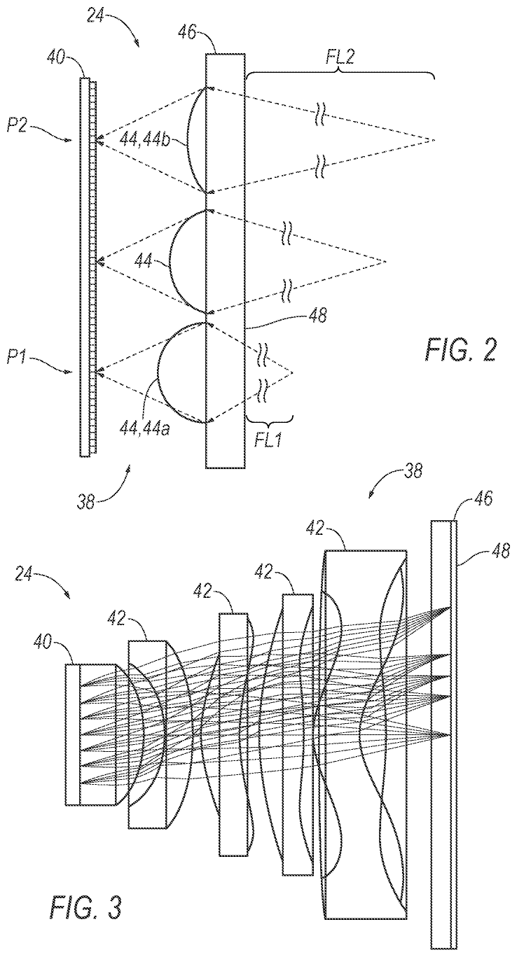

The camera assembly 24 captures image data that specifies light detected by the camera assembly 24, e.g., color, brightness, hue, etc. at each of a plurality of pixels of an image sensor 40 of the camera assembly 24. The image sensor 40 detects light and generates electric information based on the detected light. The image sensor 40 may be, for example, a charge-coupled device (CCD) or an active-pixel sensor (CMOS sensor). In addition to the image sensor 40, the camera assembly 24 may include a lens assembly 38 having one or more lenses that focus light for detection by the image sensor 40. With reference to FIG. 2. the lens assembly 38 may include one or more micro lens 44, e.g., arranged in an array. Each micro lens 44 may have width that is less than or equal to 1 millimeter. Each micro lens 44 may focus light on a certain subset of the pixels of the image sensor 40. In other words, the micro lens 44 may focus lights on only a portion of, and not all, the pixels of the image sensor 40. The micro lenses 44 may define different focal lengths than each other, e.g., a first micro lens 44a may define the first focal length FL1 and a second micro lens 44b may define the second focal length FL2. With reference to FIG. 3, the lens assembly 38 may include a plurality of lenses 42 arranged in series. One or more lens 42 of the series may be movable toward or away from each other, e.g., to adjust focal length. The camera assembly 24, e.g., the lens assembly 38, may include one or more micro mirror (not shown). Each micro mirror may reflect light that is detected by only a portion of, and not all, the pixels of the image sensor 40. The lens assembly 38 may include an array of micro mirrors. Each micro mirror may be movable relative to each other. The micro mirrors may be moved by actuators configured to move micro mirrors, e.g., as conditionally known and in response to a command from the computer 26. The lens assembly 38 may include any number of lenses 42 and/or micro lenses 44, e.g., arranged in an array and/or in series.

The camera assembly 24 is designed to capture image data or solve the plenoptic function using captured image data to generate images at a plurality of focal lengths, e.g., first image data at the first focal length FL1 and second image at the second focal length FL2 that is different than the first focal length FL1. As one example, one or more lens or mirror of the lens assembly 38 may be translatable and/or rotatable relative to the image sensor 40, another lens of the lens assembly 38 and/or another optical element of lens assembly 38 or the camera assembly 24 (e.g., a mirror, a transparent shield 46, etc.). Movement of the lens or mirror may change the focal length for the captured image data. The camera assembly 24 may include an actuator that moves the lens or mirror, e.g., in response to a command from the computer 26. The actuator may include an electric motor or other suitable structure for moving the lens or mirror, e.g., including those conventionally known.

As another example, the micro lenses 44 of the lens assembly 38 may focus light at a plurality of portions of the image sensor 40 and at various focal lengths. For example, the lens assembly 38 may include the first micro lens 44a that defines the first focal length FL1 and is positioned to direct light at a first portion P1 of the image sensor 40, and the lens assembly 38 may include a second micro lens 44b that defines the second focal length FL2 and is positioned to direct light at a second portion of the image sensor 40. The first portion and the second portion of the image sensor 40 are different, i.e., include different sub-sets of the pixels on different areas of the image sensor 40. The lens assembly 38 may include additional micro lenses 44 positioned to direct light other portions of the image sensor 40 and that define different focal lengths, e.g., a third micro lens that is positioned to direct light at a third portion of the image sensor 40 and that defines a third focal length, etc. Similarly, the micro mirrors of the camera assembly 24 may be moved to provide the first focal length FL1, the second focal length FL2, etc., to different portions of the image sensor 40.

As another example, the camera assembly 24 may include a plenoptic camera that detects a direction of travel of detected light waves, e.g., in addition to detecting intensity, amplitude, frequency, etc., of the light waves. The information specifying the light detected by the plenoptic camera, e.g., the intensity and direction, may be processed using conventional techniques to provide the first image data captured by the camera assembly 24 at the first focal length FL1, the second image data captured by the camera assembly 24 at the second focal length FL2, etc. The plenoptic camera may include a micro lens array positioned relative to a focal plane of a main lens of the lens assembly 38 and/or positioned relative to an image plane of the image sensor 40. The plenoptic camera may include a printed film mask. The plenoptic camera may include a meta lens array, liquid crystal lens array, etc. The plenoptic camera may be, for example, a conventional light field camera.

One or more transparent shields 46 may be included in the vehicle 20 to protect components of the camera assembly 24, e.g., the image sensor 40, components of the lens assembly 38, etc. The transparent shields 46 may be fixed relative to and mounted to the body 30 of the vehicle 20. The transparent shields 46 are transparent with respect to a medium that the camera can detect, e.g., visible light detectable by. The transparent shields 46 can be, e.g., two layers of glass attached to a vinyl layer; polycarbonate; etc. The transparent shields 46 may be component of the lens assembly 38. The transparent shield 46 may be a lens that focuses light. Each transparent shield 46 includes an outer surface 48 that generally faces away from the vehicle 20 and in a facing direction of the respective camera assembly 24. The outer surface 48 of transparent shield 46 may be visually obstructed, e.g., with dirt, condensation, liquid droplets, frost, insects, leaves, etc.

With reference to FIG. 4, the vehicle 20 may include the cleaning system 28 to clean the outer surfaces 48 of the transparent shields 46. The cleaning system 28 may blow air and/or a jet or supply a spray of liquid to clean the outer surfaces 48. The cleaning system 28 may supply the compressed air and/or the jet or spray of liquid in response to a command from the computer 26.

The cleaning system 28 may provide air. For example, the cleaning system 28 may include a compressor, a filter, air supply lines, air nozzles, and/or valves. The compressor, the filter, the air nozzles and the valves are fluidly connected to each other, i.e., fluid can flow from one to the other in sequence through the air supply lines. The compressor increases the pressure of a gas by reducing a volume of the gas or by forcing additional gas into a constant volume. The compressor may be any suitable type of compressor, e.g., a positive-displacement compressor such as a reciprocating, ionic liquid piston, rotary screw, rotary vane, rolling piston, scroll, or diaphragm compressor; a dynamic compressor such as an air bubble, centrifugal, diagonal, mixed-flow, or axial-flow compressor; or any other suitable type. The filter removes solid particulates such as dust, pollen, mold, dust, and bacteria from air flowing through the filter. The filter may be any suitable type of filter, e.g., paper, foam, cotton, stainless steel, oil bath, etc. The air supply lines extend from the compressor to the filter and from the filter to the air nozzles. The air supply lines may be, e.g., flexible tubes. The air nozzles are positioned to direct air across the transparent shields 46. For example, one air nozzle may be aimed at the outer surface 48 of one transparent shield 46 and another air nozzle may be aimed at a second outer surface 48 of a second transparent shield 46. The air nozzles may direct air at different portions of the outer surface 48 of the transparent shield 46. For example, one air nozzle may direct air at one portion of the outer surface 48 and another air nozzle may direct air at a different portion of the outer surface 48. Each valve may be positioned and operable to control air flow to one of the air nozzles. Specifically, fluid from the air supply line from the compressor must flow through one of the valves to reach the respective air supply line providing air to the respective air nozzle. The valves control flow by being actuatable between an open position permitting flow and a closed position blocking flow from the incoming to the outgoing of the air supply lines. The valves can be solenoid valves. As a solenoid valve, each valve includes a solenoid and a plunger. Electrical current through the solenoid generates a magnetic field, and the plunger moves in response to changes in the magnetic field. The solenoid moves the plunger between a position in which the valve is open and a position in which the valve is closed.

The cleaning system 28 may provide liquid. For example, the cleaning system 28 may include a reservoir, a pump, valves, liquid supply lines, and liquid nozzles. The reservoir, the pump, and the liquid nozzles are fluidly connected to each other i.e., fluid can flow from one to the other. The cleaning system 28 may distribute washer fluid stored in the reservoir to the liquid nozzles. Washer fluid is any liquid stored in the reservoir for cleaning. The washer fluid may include solvents, detergents, diluents such as water, etc. The reservoir may be a tank fillable with liquid, e.g., washer fluid for window cleaning. The reservoir may be disposed in a front of the vehicle 20 (e.g., in an engine compartment forward of the passenger cabin), in a housing of the roof, or any suitable position. The reservoir may store the washer fluid only for supplying cleaning the transparent shields 46 or also for other purposes, such as supply to clean a windshield of the vehicle 20. The pump may force the washer fluid through the liquid supply lines to the liquid nozzles with sufficient pressure that the washer fluid sprays from the liquid nozzles. The pump is fluidly connected to the reservoir. The pump may be attached to or disposed in the reservoir. The liquid supply lines extend from the pump to the liquid nozzles. The liquid supply lines may be, e.g., flexible tubes. Each liquid nozzle is fixedly positioned to eject liquid onto the transparent shield 46 in the field-of-view of the respective optical. For example, one liquid nozzle may be aimed at the outer surface 48 of one transparent shield 46 and another liquid nozzle may be aimed at a second outer surface 48 of a second transparent shield 46. The air liquid may direct liquid at different portions of the outer surface 48 of the transparent shield 46. For example, one liquid nozzle may direct liquid at one portion of the outer surface 48 and another liquid nozzle may direct liquid at a different portion of the outer surface 48. The liquid nozzles may be supported by the housing, the body 30 panels of the vehicle 20, or any suitable structure. Each valve may be positioned and operable to control fluid flow from the pump to one of the liquid nozzles. Specifically, fluid from the liquid supply line from the pump must flow through one of the valves to reach the respective liquid supply line providing fluid to the respective liquid nozzle. The valves control flow by being actuatable between an open position permitting flow and a closed position blocking flow from the incoming to the outgoing of the liquid supply lines. The valves can be solenoid valves. As a solenoid valve, each valve includes a solenoid and a plunger. Electrical current through the solenoid generates a magnetic field, and the plunger moves in response to changes in the magnetic field. The solenoid moves the plunger between a position in which the valve is open and a position in which the valve is closed.

With continued reference to FIG. 4, the vehicle 20 may include the computer 26 to autonomously or semi-autonomously operate the vehicle 20 and/or actuate the cleaning system 28. The computer 26 is generally arranged for communications on a communication network 50 that can include a bus in the vehicle 20 such as a controller area network (CAN) or the like, and/or other wired and/or wireless mechanisms. In some implementations, communication network 50 can include a network in which messages are conveyed using other wired communication technologies and/or wireless communication technologies e.g., Ethernet, WiFi, Bluetooth, etc. Via the communication network 50, the computer 26 may transmit messages to various devices in the vehicle 20, and/or receive messages (e.g., CAN messages) from the various devices, e.g., the camera assemblies 24, the cleaning system 28, the brake system 34, the propulsion system 32, etc. Alternatively or additionally, in cases where the computer 26 comprises a plurality of devices, the communication network 50 may be used for communications between devices represented as the computer 26 in this disclosure.

The computer 26 includes a processor and a memory. The memory includes one or more forms of computer 26 readable media, and stores instructions executable by the processor for performing various operations, processes, and methods, as disclosed herein. For example, the computer 26 can be a generic computer with a processor and memory as described above and/or may include an electronic control unit (ECU) or controller for a specific function or set of functions, and/or a dedicated electronic circuit including an ASIC that is manufactured for a particular operation, e.g., an ASIC for processing image data and/or communicating the image data. In another example, computer 26 may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured deployable based on VHDL programming provided pre-manufacturing, whereas logical components inside an FPGA may be configured deployable based on VHDL programming, e.g., stored in a memory electrically connected to the FPGA circuit. In some examples, a combination of processor(s), ASIC(s), and/or FPGA circuits may be included in the computer 26. The memory can be of any type, e.g., hard disk drives, solid state drives, servers, or any volatile or non-volatile media. The memory can store the collected data sent from the sensors.

The computer 26 is programmed to, i.e., the memory may store instructions executable by the processor to, receive first image data captured at the first focal length FL1 from the camera assembly 24 and receive second image data captured at the second focal length FL2 from the camera assembly 24. The first focal length FL1 and the second focal length FL2s are different than each other. In other words, the second focal length FL2 is greater than the first focal length FL1 or vice versa. The first focal length FL1 and the second focal length FL2 may be predetermined, e.g., based on testing that indicates, for example, an amount of difference that provides sufficient information to make the various determinations discussed herein. The testing may indicate a maximum and/or minimum length for the first focal length FL1 and/or the second focal length FL2. The testing may be based on real world images and/or simulated images, discussed below. For example, the first focal length FL1 may between the camera assembly 24 and a front end of the vehicle 20, and the second focal length FL2 is beyond the front end of the vehicle 20. As another example, the first focal length FL1 may be within 40 to 160 millimeters of the camera assembly 24, e.g., within 40 to 160 millimeters of the outer surface 48 of the respective outer shield, and the second focal length FL2 is at least 10 meters from the camera assembly 24, e.g., 100 meters.

The computer 26 receives image data, including the first image date and the second image data from the camera assembly 24 via the communication network 50, e.g., as data indicating the color, brightness, hue, etc. detected at each of the pixels of the image sensor 40. The first image data and the second imaged data may include a same scene, i.e., include images captured from a common position, orientation, and field-of-view. The first image data and the second imaged data may be captured at a same time. The computer 26 may receive the image data from the camera assembly 24 in response to a request send to the camera assembly 24. The request may include the first focal length FL1 and the second focal length FL2. The computer 26 may receive the image data from the camera assembly 24 as a matter of course, e.g., the camera assembly 24 may automatically transmit image data to the computer 26, e.g., substantially continuously or at intervals.

The computer 26 may calculate or otherwise identify the first image data and the second image data in the image data received from the camera assembly 24. For example, the computer 26 may identify image data from pixels at the first portion the image sensor 40 that detects light from the first micro lens 44 that defines the first focal length FL1 as providing the first image data and may identify image data from pixels at the second portion the image sensor 40 that detects light from the second micro lens 44 that defines the second focal length FL2 as providing the second image data. As another example, the image data from the camera assembly 24 may include data indicating the focal length, and the computer 26 may identify the first image data and the second image data base on the indication. As another example, when the camera assembly 24 is a platonic camera the computer 26 may calculate the first image data and the second image data from data from the platonic camera that provided image data indicating the direction of travel of detected light waves, e.g., using conventional mathematical models and techniques.

The computer 26 is programmed to actuate one or more vehicle systems based on the image data captured at the first focal length FL1 and the image data captured at second focal length FL2. For example, the computer 26 may actuate the cleaning system 28, the propulsion system 32, the brake system 34, and/or the steering system 36 based on the first image data captured at the first focal length FL1 and the second image data captured at the second focal length FL2. The image data at the first focal length FL1 and the second focal length FL2 provides more information about an object represented in such data, e.g., relative to information about an object represented in image data at a single focal length. The computer 26 may use the image data captured at the first focal length FL1 and the image data captured at second focal length FL2 as input information to make various determinations regarding an object in the first image data and/or the second image data.

The computer 26 may for example, analyze the image data captured at the first focal length FL1 and the second focal length FL2 to determine whether an object in the field of view of the camera and in the first image data and/or the second image data is either on the vehicle 20, e.g., on the outer surface 48 of transparent shield 46 or spaced from the outer surface 48 of transparent shield 46 based on the image data captured at the first focal length FL1 and the second focal length FL2. When the object is spaced from the vehicle 20, e.g., spaced from the outer surface 48 of the transparent shield 46, the computer 26 may command one or more of the propulsion system 32, the brake system 34, and/or the steering system 36, e.g., to maintain a certain distance from the object, to maintain a certain distance from the object, etc. As another example, e.g., after determining the object is on the transparent shield 46, the computer 26 may analyze the image data captured at the first focal length FL1 and the second focal length FL2 to determine whether the object is either solid or liquid based on the first image data captured at the first focal length FL1 and the second image data captured at the second focal length FL2. If the object is on the transparent shield 46 is liquid, the computer 26 may command the cleaning system 28 to blow air remove the object. If the object is on the transparent shield 46 is not liquid, the computer 26 may command the cleaning system 28 to spray cleaning fluid air remove the object. The computer 26 may additionally actuate a wiper (not shown) or the like.

The computer 26 may analyze the image data captured at the first focal length FL1 and the second focal length FL2 with a deep neural network (DNN). The DNN can be a software program that can be loaded in memory and executed by a processor included in the computer 26, for example. In an example implementation, the DNN can include, but is not limited to, a convolutional neural network CNN, R-CNN Region-based CNN, Fast R-CNN, and Faster R-CNN. The DNN includes multiple nodes or neurons. The neurons are arranged so that the DNN includes an input layer IL, one or more hidden layers HL, and an output layer OL. Each layer of the DNN can include a plurality of neurons. While three hidden layer HLs are illustrated, it is understood that the DNN can include additional or fewer hidden layer HLs. The input and output layer OLs may also include more than one node. As one example, the DNN can be trained with ground truth data, i.e., data about a real-world condition or state. For example, the DNN can be trained with ground truth data and/or updated with additional data. Weights can be initialized by using a Gaussian distribution, for example, and a bias for each node can be set to zero. Training the DNN can include updating weights and biases via suitable techniques such as back-propagation with optimizations. Ground truth data means data deemed to represent a real-world environment, e.g., conditions and/or objects in the environment. Thus, ground truth data can include sensor data depicting an environment, e.g., an object in an environment, along with a label or labels describing the environment, e.g., a label describing the object. Ground truth data can further include or be specified by metadata such as a location or locations at which the ground truth data was obtained, a time of obtaining the ground truth data, etc.

The DNN of the computer 26 may be trained to determine whether the object in the field of view of the camera is either the on the vehicle 20 or the spaced from the vehicle 20, e.g., whether the object is on or spaced from the outer surface 48 of the transparent shield 46, based on the first image data captured at the first focal length FL1 and the second image data captured at the second focal length FL2. In other words, the DNN may by trained such that information provided by the output layer OL of the DNN indicates that the object is either on the vehicle 20 or the spaced from the vehicle 20, e.g., whether the object is on or spaced from the outer surface 48 in response to providing the first image data captured at the first focal length FL1 and the second image data captured at the second focal length FL2 as input information to the input layer IL of the DNN.

To determine whether the object is on or spaced from the vehicle 20, the DNN may be trained with ground truth data that includes data indicating pairs of images. Each pair of images includes data indicating a first training image captured at the first focal length FL1 and indicating a second training image captured at the second focal length FL2. Each pair of images may be of the same scene and captured at a same time. The pair of images may include images captured of the real world, e.g., based on actual light detected by an image sensor 40. The pair of images may be simulated, e.g., generated with software that simulates images of simulated scenes captured as various focal lengths. The simulated images may be generated, for example, using the Unreal Engine 5 available from Epic Games, Inc., or with other conventional software such as Zemax, CodeV, Lightools, FRED, OSLO, TracePro, etc. The ground truth data may include labels that indicate whether each pair of images includes an object on or spaced from the vehicle 20 or outer surface 48 of the transparent shield 46. Weights of the hidden layer HL may be adjusted, e.g., as described above, such that providing the pairs of images to the input layer IL outputs the corresponding label at the output layer OL.

The DNN of the computer 26 may be trained to determine whether the object in the field of view of the camera is either solid or liquid based on the first image data captured at the first focal length FL1 and the second image data captured at the second focal length FL2. In other words, the DNN may by trained such that information provided by the output layer OL of the DNN indicates that the object is either liquid of solid in response to providing the first image data captured at the first focal length FL1 and the second image data captured at the second focal length FL2 as input information to the input layer IL of the DNN.

To determine whether the object is solid or liquid, the DNN may be trained with ground truth data that includes data indicating pairs of images, each pair of images including data indicating a first training image captured at the first focal length FL1 and indicating a second training image captured at the second focal length FL2, e.g., as described above. The pairs of images may include images captured of the real world and/or may be simulated, e.g., as described above. The ground truth data may include labels that indicate whether each pair of images includes an object that is liquid or is solid. Weight of the hidden layer HLs may be adjusted, e.g., as described above, such that providing the pairs of images to the input layer IL outputs the corresponding label at the output layer OL.

The DNN of the computer 26 may be trained to identify fog entrapped in the lens assembly 38 based on the first image data captured at the first focal length FL1 and the second image data captured at the second focal length FL2. Fog entrapped in the lens assembly 38 may be on one or more lens or mirrors of the lens assembly 38. In response to identifying fog entrapped the lens assembly 38 the computer 26 may log a diagnostic code in memory, actuate a user interfacing indicating the fog, transmit a service request, etc.

To identify fog entrapped in the lens assembly 38, the DNN may be trained with ground truth data that includes data indicating pairs of images, each pair of images including data indicating a first training image captured at the first focal length FL1 and indicating a second training image captured at the second focal length FL2, e.g., as described above. The pairs of images may include images captured of the real world and/or may be simulated, e.g., as described above. The ground truth data may include labels that indicate whether each pair of images indicates fog entrapped in the lens assembly 38. Weight of the hidden layer HLs may be adjusted, e.g., as described above, such that providing the pairs of images to the input layer IL outputs the corresponding label at the output layer OL.

The computer 26 may be programmed to actuate the brake system 34, the steering system 36, and/or the propulsion system 32, e.g., by transmit commands to the respective system 32, 34, 36 via the communication network 50. For example, the computer 26 may command a pump and/or valve of the brake system 34 to increase or decrease fluid pressure provided to brake cylinders at one or more of the wheels to increase or decrease resistance to motion. The computer 26 may command an internal combustion and/or electric motor of the propulsion system 32 to increase or decrease an amount of torque provided to one or more wheels of the vehicle 20. The computer 26 may command a motor, servo, pump and/or valve of the steering system 36 to pivot the wheels of the vehicle 20 toward the right or the left.

The computer 26 may actuate at least one of the brake system 34, the steering system 36, or the propulsion system 32 in response to determining that the object is spaced from the vehicle 20, e.g., from the outer surface 48 of the transparent shield 46. For example, after determining the object is spaced from the vehicle 20, the computer 26 may identify the object in the first image data and/or the second image data as a pedestrian, a vehicle 20, a lane marking, etc., and may actuate the brake system 34, the steering system 36, and/or the propulsion system 32 to maintain a certain distance from the object, maintain a certain distance from the object, etc. The computer 26 may identify the object and actuate the brake system 34, the steering system 36, and/or the propulsion system 32 using image recognition techniques, using supplemental data from other sensors (such as LIDAR and other range finding devices), and conventional techniques.

The computer 26 may be programed to select a subset of the air nozzles or the liquid nozzles from among the plurality the air nozzles or the liquid nozzles of the cleaning system 28 based on the first image data captured at the first focal length FL1 and the second image data captured at the second focal length FL2. For example, the computer 26 may identify the subset of the air nozzles or the liquid nozzles based on a location of the object in the image data, e.g., relative to border of the field of view. The computer 26 may select the subset such that the selected air nozzles and/or liquid nozzles direct fluid toward the object. The computer 26 may use, for example, a look up table or the like that associates various locations on the outer surface 48 of the transparent shield 46 with various selected air nozzles and/or liquid nozzles. Air nozzles and/or liquid nozzles that are not directed toward the object may not be include in the subset.

The computer 26 may be programmed to actuate the cleaning system 28. For example, the computer 26 may transit instructions to the cleaning system 28 via the communication network 50. The computer 26 may actuate the cleaning system 28 to provide air. For example, the command may instruct actuation of the compressor of the cleaning system 28 to an on state, actuation of the valve that controls air flow from to one of the air nozzles to an open state, etc. The computer 26 may actuate the cleaning system 28 to provide liquid. For example, the command may instruct actuation of the pump of the cleaning system 28 to an on state, etc. The computer 26 may actuate the cleaning system 28 to provide air and/or liquid to some nozzles of the cleaning system 28 and not others, e.g., only to the subset of air nozzles and/or liquid selected based on the first image data and the second image data. For example, the computer 26 may command one or more valves that control fluid flow to the selected subset of nozzles to open positions and command other valves that control fluid flow to other nozzles to closed positions. The computer 26 may actuate the cleaning system 28 in response to determining the object is on the vehicle 20. For example, the computer 26 may actuate the cleaning system 28 to provide air in response to determining the object on the vehicle 20, e.g., on the transparent shield 46, is liquid. The computer 26 may actuate the cleaning system 28 to provide liquid in response to determining the object is solid.

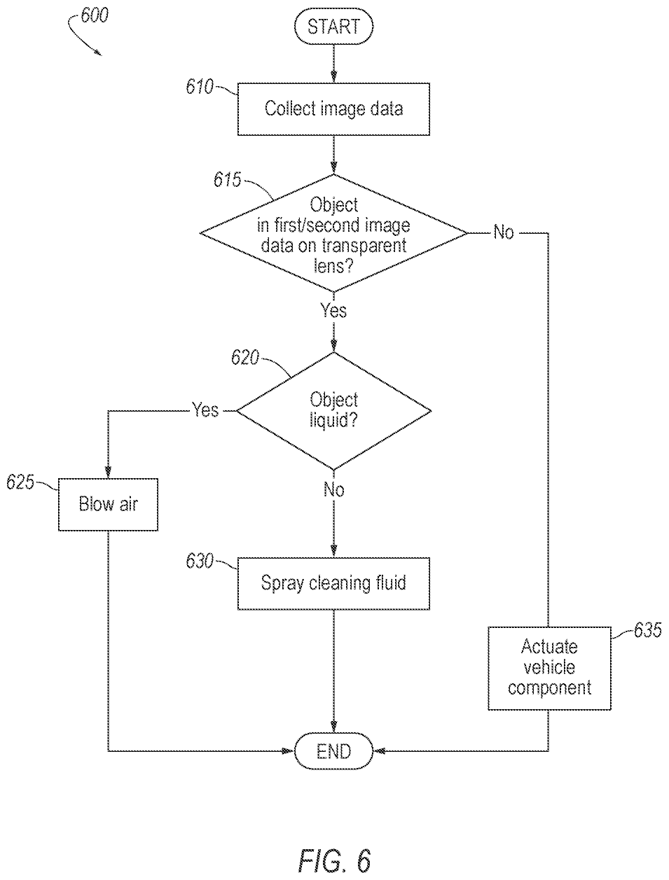

With reference to FIG. 6, a flow chart illustrating the process 600 for controlling the cleaning system 28, the brake system 34, the steering system 36, and/or the propulsion system 32 based on the first image data captured at the first focal length FL1 and the second image data captured at the second focal length FL2 is shown. The process 600 starts at a block 610 where the computer 26 collects data, e.g., from the cameras, etc., e.g., via the communication network 50. For example, the computer 26 may receive image data from the computer 26 the camera assembly 24 that includes the first image data and the second image data, and/or the computer 26 may calculate the first image data and the second imaged data from the image data received from the camera assembly 24, e.g., as described above. The computer 26 may collect such data continuously, at intervals (e.g., every 100 milliseconds), etc. The computer 26 may collect such data throughout the process 600.

At a block, 615 the computer 26 determines whether an object in the first image data captured at the first focal length FL1 and/or the second image data captured at the second focal length FL2 is on or spaced from the vehicle 20, e.g., whether the object is on or spaced from the outer surface 48 of the transparent shield 46. The computer 26 determines whether the object is on or spaced from the vehicle 20 based on the first image data captured at the first focal length FL1 and the second image data captured at the second focal length FL2. For example, the computer 26 may use a DNN trained to output whether the object is on or spaced from the vehicle 20 based on an input of whether the first image data and the second image data, e.g., as described herein. In response to determining the object is on the vehicle 20 the computer 26 moves to a block 620. In response to determining the object is not on the vehicle 20, e.g., the object is spaced from the vehicle 20, the computer 26 moves to a block 635.

At the block 620 the computer 26 determines whether the object in the first image data captured at the first focal length FL1 and/or the second image data captured at the second focal length FL2 is liquid or solid. The computer 26 determines whether the object is liquid or solid based on the first image data captured at the first focal length FL1 and the second image data captured at the second focal length FL2. For example, the computer 26 may use a DNN trained to output whether the object is liquid or solid based on an input of the first image data and the second image data, e.g., as described herein. In response to determining the object is liquid the computer 26 moves to a block 625. In response to determining the object is not liquid, e.g., the object is solid, the computer 26 moves to a block 635.

At the block 625 the computer 26 actuates the cleaning system 28 to provide air to the air nozzles, e.g., by transmitting a command via the communication network 50 and as described herein. The computer 26 may command the cleaning system 28 to provide air only via a selected subset of the air nozzles to clear the liquid from the field of view indicated by the object identified in the first image data and the second image data. After the block 625 the process 600 may end. Alternately, the computer 26 may return to the block 610.

At the block 630 the computer 26 actuates the cleaning system 28 to provide liquid to the liquid nozzles, e.g., by transmitting a command via the communication network 50 and as described herein. The computer 26 may command the cleaning system 28 to provide liquid only via a selected subset of the liquid nozzles to clear the solid from the field of view indicated by the object identified in the first image data and the second image data. After the block 630 the process 600 may end. Alternately, the computer 26 may return to the block 610.

At the block 635 the computer 26 actuates at least one of the brake system 34, the steering system 36, or the propulsion system 32 based on the first image data captured at the first focal length FL1 and the second image data captured at the second focal length FL2. For example, the computer 26 may command the brake system 34, the steering system 36, or the propulsion system 32 via communication network 50 to maintain a certain distance from the object identified in the first image data and the second image data as being spaced from the vehicle 20, maintain a certain distance or position relative to the object, etc., e.g., using conventional ADAS algorithms and programming. After the block 635 the process 600 may end. Alternately, the computer 26 may return to the block 610.

In the drawings, the same reference numbers indicate the same elements. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted.

The adjectives “first” and “second” are used throughout this document as identifiers and do not signify importance, order, or quantity.

Computer executable instructions may be compiled or interpreted from computer programs created using a variety of programming languages and/or technologies, including, without limitation, and either alone or in combination, Java, C, C, Visual Basic, Java Script, Python, Perl, HTML, etc. In general, a processor e.g., a microprocessor receives instructions, e.g., from a memory, a computer readable medium, etc., and executes these instructions, thereby performing one or more processes, including one or more of the processes described herein. Such instructions and other data may be stored and transmitted using a variety of computer readable media. A file in a networked device is generally a collection of data stored on a computer readable medium, such as a storage medium, a random-access memory, etc. A computer readable medium includes any medium that participates in providing data e.g., instructions, which may be read by a computer. Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Use of in “response to,” “based on,” and “upon determining” herein indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A system, comprising:
a camera assembly designed to capture image data at a plurality of focal lengths; and
a computer in communication with the camera assembly, the computer having a processor and a memory storing instructions executable by the processor to:
receive first image data captured by the camera assembly at a first focal length;
receive second image data captured by the camera assembly at a second focal length, the second focal length greater than the first focal length; and
actuate a cleaning system based on the first image data captured at the first focal length and the second image data captured at the second focal length.

2. The system of claim 1, wherein the instructions include instructions to actuate at least one of a brake system, a steering system, or a propulsion system based on the first image data captured at the first focal length and the second image data captured at the second focal length.

3. The system of claim 2, further comprising a transparent shield with an outer surface and wherein the instructions include instructions to:
determine whether an object in a field of view of the camera assembly is either on the outer surface or spaced from the outer surface based on the first image data captured at the first focal length and the second image data captured at the second focal length;
in response to determining the object is on the outer surface, actuate the cleaning system; and
in response to determining the object is spaced from the outer surface, actuate at least one of the brake system, the steering system, or the propulsion system.

4. The system of claim 3, wherein the instructions include instructions to determine whether the object in the field of view of the camera assembly is either on the outer surface or spaced from the outer surface with a neural network trained to use the first image data captured at the first focal length and the second image data captured at the second focal length as input data.

5. The system of claim 1, wherein the instructions include instructions to actuate the cleaning system to provide either air or liquid based on the first image data captured at the first focal length and the second image data captured at the second focal length.

6. The system of claim 5, wherein the instructions include instructions to:
determine whether an object is either solid or liquid based on the first image data captured at the first focal length and the second image data captured at the second focal length;
in response to determining the object is liquid, actuate the cleaning system to provide air; and
in response to determining the object is solid, actuate the cleaning system to provide liquid.

7. The system of claim 1, wherein the instructions include instructions to select a subset of nozzles from among a plurality of nozzles of the cleaning system based on the first image data captured at the first focal length and the second image data captured at the second focal length, and instructions to actuate the cleaning system to provide fluid via the selected subset of nozzles.

8. The system of claim 1, wherein the camera assembly includes a lens assembly and the instructions include instructions to identify fog entrapped in the lens assembly based on the first image data captured at the first focal length and the second image data captured at the second focal length.

9. The system of claim 1, wherein the camera assembly includes a plenoptic camera.

10. The system of claim 1, wherein the camera assembly includes an image sensor, a first micro lens defining the first focal length and positioned to direct light at a first portion of the image sensor, and a second micro lens defining the second focal length and positioned to direct light at a second portion of the image sensor.

11. The system of claim 1, wherein the first focal length is within 40 to 160 millimeters of the camera assembly and the second focal length is at least 10 meters from the camera assembly.

12. A vehicle, comprising:
a propulsion system;
a brake system;
a steering system;
a camera assembly; and
a computer in communication with the camera assembly, the computer having a processor and a memory storing instructions executable by the processor to:
receive first image data captured at a first focal length from the camera assembly;
receive second image data capture at a second focal length from the camera assembly, the second focal length greater than the first focal length; and
actuate at least one of the propulsion system, the brake system, or the steering system based on the first image data captured at the first focal length and the second image data captured at the second focal length.

13. The vehicle of claim 12, further comprising a cleaning system, and wherein the instructions include instructions to actuate the cleaning system based on the first image data captured at the first focal length and the second image data captured at the second focal length.

14. The vehicle of claim 13, wherein the instructions include instructions to:
determine whether an object in a field of view of the camera assembly is either on the vehicle or spaced from the vehicle based on the first image data captured at the first focal length and the second image data captured at the second focal length;
in response to determining the object is on the vehicle, actuate cleaning system; and
in response to determining the object is spaced from the vehicle, actuate at least one of the brake system, the steering system, or the propulsion system.

15. The vehicle of claim 14, wherein the instructions include instructions to determine whether the object in the field of view of the camera is either on the vehicle or spaced from the vehicle with a neural network trained to use the first image data at the first focal length and the second image data at the second focal length as input data.

16. The vehicle of claim 12, wherein the first focal length is between the camera assembly and a front end of the vehicle, and the second focal length is beyond the front end of the vehicle.

17. A method, comprising:
receiving first image data captured by a camera assembly at a first focal length;
receiving second image data captured by the camera assembly at a second focal length, the second focal length greater than the first focal length; and
actuating a cleaning system based on the first image data captured at the first focal length and the second image data captured at the second focal length; or actuating at least one of a brake system, a steering system, or a propulsion system based on the first image data captured at the first focal length and the second image data captured at the second focal length.

18. The method of claim 17, further comprising actuating the cleaning system to provide either air or liquid based on the first image data captured at the first focal length and the second image data captured at the second focal length.

19. The method of claim 17, further comprising identifying fog entrapped in a lens assembly of the camera assembly based on the first image data captured at the first focal length and the second image data captured at the second focal length.
